(19) United States
(12) Patent Application Publication
(10) Pub. No.: US 2017/0267916 A1
(43) Pub. Date: Sep. 21, 2017

(54) CHEMICAL SUSPENSIONS FOR PRECISE CONTROL OF HYDROCARBON RESERVOIR TREATMENT FLUIDS

(71) Applicant: Halliburton Energy Services, Inc., Houston, TX (US)

(72) Inventors: Dipti SINGH, Kingwood, TX (US); Lucas Kurtis FONTENELLE, Houston, TX (US); Jeremy HOLTSCLAW, Kingwood, TX (US)

(21) Appl. No.: 15/505,135

(22) PCT Filed: Sep. 26, 2014
(86) PCT No.: PCT/US2014/057652

§ 371 Date: Feb. 20, 2017

(51) Int. Cl. C09K 8/68; E21B 43/267; C09K 8/60; C09K 8/88; C09K 8/528

(52) U.S. Cl. CPC C09K 8/68; C09K 8/685; C09K 8/887; C09K 8/528; C09K 8/605; E21B 43/267; C09K 2208/26; C09K 2208/12; C09K 2208/24; C09K 2208/28

(57) ABSTRACT

Compositions and methods for formulating a liquid gel concentrate package with all the additives for a well servicing fluid are provided. An embodiment of the present disclosure is a method comprising: providing a liquid gel concentrate package comprising: a liquid gel concentrate; and at least two active ingredients, wherein the active ingredients comprise constituents of a well servicing fluid; and allowing the liquid gel concentrate package to blend with an aqueous fluid to form a well servicing fluid; and introducing the well servicing fluid into a wellbore penetrating at least a portion of a subterranean formation. Another embodiment of the present disclosure is a composition comprising a liquid gel concentrate; and at least two active ingredient, wherein the active ingredients comprise constituents of a well servicing fluid.

### BACKGROUND

The present disclosure provides compositions and methods for formulating a liquid gel concentrate package with additives for a well servicing fluid.

Oilfield operations can involve drilling into a variety of subterranean formations. While porous subterranean formations allow hydrocarbons to flow freely to the well bore, other less permeable formations can inhibit the flow of hydrocarbons. These less permeable formations include, but are not limited to, shale plays and rocks that have one to several hundred (up to about 1000) millidarcies. A variety of techniques can be used to enhance the production from less permeable subterranean zones.

Hydraulic fracturing is one such process that is commonly used to increase the flow of desirable fluids from a portion of a subterranean formation. Traditional hydraulic fracturing operations usually comprise the steps of placing a viscous fracturing fluid (often an aqueous gelled fluid) into a portion of a subterranean formation at a rate and pressure such that fractures are created or enhanced in a portion of the subterranean formation. The fractures propagate, for example, as vertical and/or horizontal cracks radially outward from the well bore. The fracturing fluid may comprise particulates, often referred to as “proppant particulates,” that are deposited in the fractures. The proppant particulates function to prevent the fractures from fully closing upon the release of pressure, forming conductive channels through which fluids may flow to (or from) the well bore.

In many operations, fracturing fluids and other well servicing fluids are formulated at the well site. In some cases, certain constituents of the fracturing fluid exist in a dry form that is added to water at the well site. In other cases, a highly concentrated fluid containing the same chemical constituents can be added to water. These processes may require transportation and handling of hundreds of pounds of solid materials or concentrated fluid. As different solid materials may be sourced from different suppliers, coordinating their delivery at the well site and mixing the appropriate proportions on location may present significant challenges. Moreover, the success of chemical mixtures in current field operations, such as fracturing fluids, often depends on the operational efficiency of pumps. Many examples of failed fracturing jobs exist because of the failure of chemical additive pumps, the failure of metering devices, or where valves were not turned on at the proper time.

### BRIEF DESCRIPTION OF THE DRAWINGS

These drawings illustrate certain aspects of some of the embodiments of the present disclosure, and should not be used to limit or define the claims.

FIG. 1 is a diagram illustrating an example of a fracturing system that may be used in accordance with certain embodiments of the present disclosure.

FIG. 2 is a diagram illustrating an example of a subterranean formation in which a fracturing operation may be performed in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF EMBODIMENTS

The present disclosure provides compositions and methods for formulating a liquid gel concentrate package with some or all of the additives included in a well servicing fluid. Pre-mixed liquid gel concentrates may, among other benefits, minimize footprints on location by allowing pre-mixing of some or all of the active ingredients of a desired well servicing fluid such as surfactants, crosslinker, biocides, etc. The compositions and methods of the present disclosure may be applied to fracturing fluids, drilling muds, cements, or other treatment fluids and provide a higher degree of control over the sequence of permeation and events downhole in an oil or gas formation.

Generally, the techniques of the present disclosure involve integrating the chemical constituents of a servicing fluid in a liquid gel concentrate formulation. This may, among other benefits, promote ease of transportation and use of such fluids and/or its chemical constituents. Well servicing fluids, such as fracturing fluids, combine various additives and often require precision metering for all the components during the job. Omitting or improperly mixing important component such as surfactant and breaker can affect clean-up and production. The present disclosure simplifies the process of chemical addition, thus allowing for more precise control of fracturing fluids or other well servicing fluids. Pre-blending all desired active components in a liquid gel concentrate not only addresses the issue of the footprint but can also make the well servicing fluid more convenient to use during the operation.

The compositions and methods of the present disclosure may also increase the portability of the constituent chemicals for well servicing fluids, increase the shelf-stability of the constituent chemicals for the well servicing fluids, and/or facilitate the onsite preparation of the well servicing fluids. To avoid any gelation or polymer degradation, buffer and oxidizers can be metered on location during operation. Using liquid gel concentrates also reduces the difficulty of adequately mixing dry additives. This may be important because certain gelling agents may be slow to hydrate, or dissolve in solution, thus leading to non-homogeneous mixing of the chemicals within the fracturing fluid.

The compositions and methods of the present disclosure generally involve a liquid gel concentrate package comprising a liquid gel concentrate and at least two active ingredients. As used herein, the term “package” does not imply any specific shape, size, or form but simply refers to the combination of components. For example, while the liquid gel concentrate package may be contained in a pouch in some embodiments, the liquid gel concentrate may exist without a pouch in other embodiments. The active ingredients generally comprise the constituent chemicals used in a well servicing fluid, such as a fracturing fluid. The compositions of the present disclosure can also include active ingredients that may thicken and transform products such as drilling mud and casing cement since these are also fluid-solid mixtures wherein the slowing down or speeding up of the structure formation and viscosification may be advantageously controllable with the compositions as described herein. In certain embodiments, the liquid gel concentrate packages may also comprise an inactive ingredient.

Generally speaking, a liquid gel concentrate is a concentrated version of a gelling agent suspended in a fluid. Examples of liquid gel concentrates suitable for the methods and compositions of the present disclosure include, but are not limited to, LGC-IV™ Liquid Gel Concentrate, LGC-VI™ Liquid Gel Concentrate, LGC-8™ Liquid Gel Concentrate, LGC-36UC™ Liquid Gel Concentrate, and LGC-39UC™ Liquid Gel Concentrate, which are each available from Halliburton Energy Services. In certain embodiments, non-commercial liquid gel concentrates may be formulated from a gelling agent and a fluid.

When a liquid gel concentrate is formulated, suitable gelling agents include, but are not limited to, guar gum, derivatized guar, gum ghatti, gum arabic, locust bean gum, cellulose, and derivatized cellulose.acetan, alginate, chitosan, curdlan, pullulan, scleroglucan, schizophyllan, stewartan, succinoglycan, xanthan, welan, starch, tamarind, tragacanth, any derivative thereof, and any combination thereof. In certain embodiments, the gelling agent is present in the liquid gel concentrate in a concentration of about 0.1% to about 50% by weight. In other embodiments, the gelling agent is present in the liquid gel concentrate in a concentration of about 0.1% to about 10% by weight. In other embodiments, the gelling agent is present in the liquid gel concentrate in a concentration of about 10% to about 50% by weight.

The gelling agent may be suspended in any suitable fluid. In certain embodiments, the gelling agent may be suspended in a liquid hydrocarbon, including but not limited to diesel, mineral oil, paraffin oil, vegetable oils, other environmentally friendly solvents, any derivative thereof, and any combination thereof. In one embodiment, the gelling agent is suspended in D/F FLUID 33™, which is available from Sonneborn. In other embodiments, the gelling agent may be suspended in an aqueous fluid, including but not limited to, fresh water, salt water, sea water, or brine.

The active ingredients may include any constituent chemicals that are used in a well servicing fluid. Examples of such well servicing fluids include, but are not limited to, fracturing fluids, well bore cements, a proppant slurry, drilling fluid or “mud,” acid treatment fluids, and fluid loss concentrates. Suitable active ingredients that maybe used according to the teaching of the present disclosure include, but are not limited to, viscosifiers, friction reducers, pH control agents, surfactants, crosslinkers, clay stabilizers, breakers, pH agents, biocides, scale inhibitors, and inorganic ion crosslinkers. The active ingredients may comprise a combination of chemicals that include a gelling agent with surfactants, biocide, or crosslinkers. The concentrations of the active ingredients can vary based on stability and reactivity of the specific active ingredients. In some embodiments, active ingredients may be present in a range from about 0.01% to about 20% by weight.

In certain embodiments, the active ingredients may be in a liquid form that may be mixed with the liquid gel concentrate. In other embodiments, active ingredients may be in a solid or dry form that may be suspended in the liquid gel concentrate. In embodiments where the active ingredient is a solid particle, the particle size may be chosen for the desired control and speed of dissolution of the active ingredient to formulate the desired well servicing fluid. In certain embodiments, granules of a solid active ingredient could be from about 20 μm to about 400 μm. In other embodiments, the granules may be from about 350 μm to about 900 μm. Small granules dissolve faster in general, and sizes can be blended to optimize the manufacturing and/or application of the compositions.

In certain embodiments, the active ingredients may be selected so that a desired well servicing fluid can be formulated simply by adding the liquid gel concentrate composition to a fluid and allowing it to blend. In certain embodiments, the blending process may be facilitated by optional processes, such as agitation or the addition of heat. Suitable aqueous fluids may include, but are not limited, fresh water, salt water, sea water, or brines. Similarly, the relative proportions of active ingredient in the liquid gel concentrate package may be adjusted to determine the final proportion of each active ingredient in the well servicing fluid. While in some embodiments, the liquid gel concentrate package may contain multiple active ingredients, in other embodiments, separate liquid gel concentrate compositions having different active ingredients may be used for a single well servicing fluid. A person of skill in the art with the benefit of the teachings of this disclosure would know what active ingredients to include in a liquid gel concentrate package and in what proportions to correspond to a particular well servicing fluid.

The inactive ingredients may include any chemical that does not interfere with the active ingredient. Inactive ingredients may comprise components which are used to make stable liquid gel concentrates. Examples of suitable inactive ingredients include, but are not limited to, a carrier fluid, a suspending agent, and combinations thereof.

The methods and compositions of the present disclosure may be used in a variety of ways. In one example, the liquid gel concentrate package containing the constituent chemicals of a well servicing fluid may be used to enable the “just add water” preparation of the well servicing fluid. In this example, the liquid gel concentrate package is added to water at the surface of the well site and allowed to blend before the resulting fluid is introduced into the wellbore. This can simplify the preparation of the well servicing fluid on site by reducing the operational footprint of the mixing process, streamlining the logistics by eliminating the need to transport different materials to the location, and reducing the level of training necessary for personnel who prepare the well service fluid. In another example, the liquid gel concentrate package of the present disclosure may be used to tailor well treatments on-the-fly by introducing the liquid gel concentrate package directly into the wellbore. In this example, the liquid gel concentrate package is allowed to blend in situ in the wellbore of the subterranean formation. The liquid gel concentrate package may be added to the fluid circulated in the wellbore at a specific location of specific time.

In one embodiment, the liquid gel concentrate package may be placed in a water soluble pouch, where upon reaction with an aqueous base fluid, the chemicals are dispersed. This dispersion may provide a localized chemical action such as a viscosity increase. While the majority of chemicals are added to a blender on the surface of the well site in current operations, placing the liquid gel concentrate package in a water soluble pouch may allow for the placement of liquid gel concentrate package (and therefore the active ingredients at different places throughout the pumping equipment in areas for enabling downhole mixing.

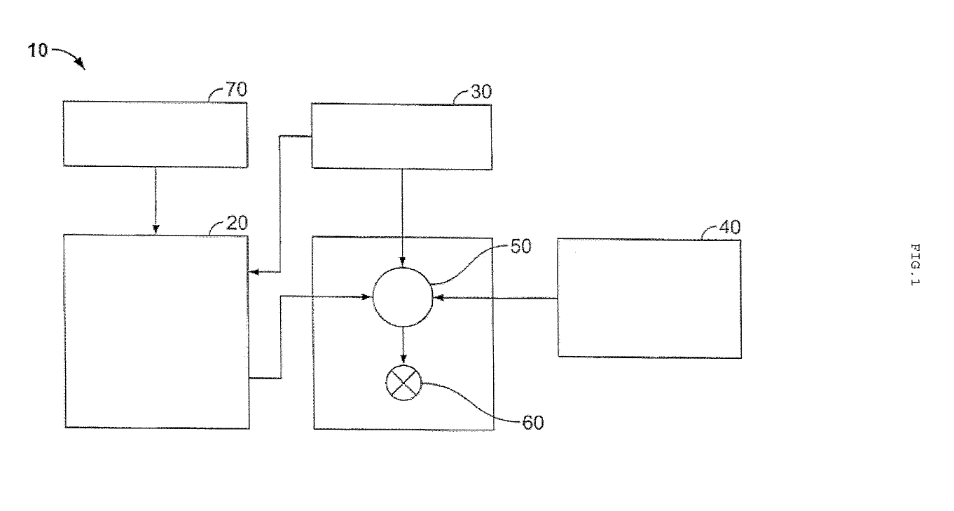

The exemplary methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a gel pre-cursor with fluid (e.g., liquid or substantially liquid) from fluid source 30, to produce a hydrated fracturing fluid that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, the fracturing fluid may comprise water, a hydrocarbon fluid, a polymer gel, foam, air, wet gases and/or other fluids.

The proppant source 40 can include a proppant for combination with the fracturing fluid. The system may also include additive source 70 that provides one or more additives (e.g., gelling agents, weighting agents, and/or other optional additives) to alter the properties of the fracturing fluid. For example, the other additives 70 can be included to reduce pumping friction, to reduce or eliminate the fluid's reaction to the geological formation in which the well is formed, to operate as surfactants, and/or to serve other functions.

The pump and blender system 50 receives the fracturing fluid and combines it with other components, including proppant from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppants, and/or other compositions to the pumping and blender system 50. Such metering devices may permit the pumping and blender system 50 can source from one, some or all of the different sources at a given time, and may facilitate the preparation of fracturing fluids in accordance with the present disclosure using continuous mixing or “on-the-fly” methods. Thus, for example, the pumping and blender system 50 can provide just fracturing fluid into the well at some times, just proppants at other times, and combinations of those components at yet other times.

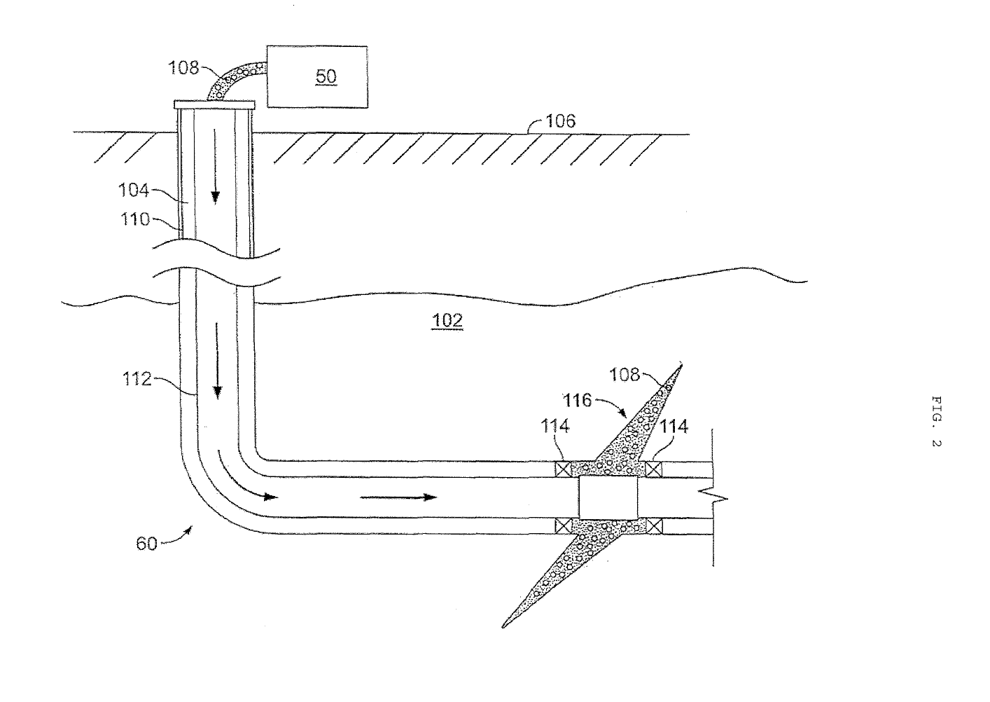

FIG. 2 shows the well 60 during a fracturing operation in a portion of a subterranean formation of interest 102 surrounding a well bore 104. The well bore 104 extends from the surface 106, and the fracturing fluid 108 is applied to a portion of the subterranean formation 102 surrounding the horizontal portion of the well bore. Although shown as vertical deviating to horizontal, the well bore 104 may include horizontal, vertical, slant, curved, and other types of well bore geometries and orientations, and the fracturing treatment may be applied to a subterranean zone surrounding any portion of the well bore. The well bore 104 can include a casing 110 that is cemented or otherwise secured to the well bore wall. The well bore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro jetting and/or other tools.

The well is shown with a work string 112 depending from the surface 106 into the well bore 104. The pump and blender system 50 is coupled a work string 112 to pump the fracturing fluid 108 into the well bore 104. The working string 112 may include coiled tubing, jointed pipe, and/or other structures that allow fluid to flow into the well bore 104. The working string 112 can include flow control devices, bypass valves, ports, and or other tools or well devices that control a flow of fluid from the interior of the working string 112 into the subterranean zone 102. For example, the working string 112 may include ports adjacent the well bore wall to communicate the fracturing fluid 108 directly into the subterranean formation 102, and/or the working string 112 may include ports that are spaced apart from the well bore wall to communicate the fracturing fluid 108 into an annulus in the well bore between the working string 112 and the well bore wall.

The working string 112 and/or the well bore 104 may include one or more sets of packers 114 that seal the annulus between the working string 112 and well bore 104 to define an interval of the well bore 104 into which the fracturing fluid 108 will be pumped. FIG. 2 shows two packers 114, one defining an uphole boundary of the interval and one defining the downhole end of the interval. When the fracturing fluid 108 is introduced into well bore 104 (e.g., in FIG. 2, the area of the well bore 104 between packers 114) at a sufficient hydraulic pressure, one or more fractures 116 may be created in the subterranean zone 102. The proppant particulates in the fracturing fluid 108 may enter the fractures 116 where they may remain after the fracturing fluid flows out of the well bore. These proppant particulates may “prop” fractures 116 such that fluids may flow more freely through the fractures 116.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

To facilitate a better understanding of the present disclosure, the following examples of certain aspects of some embodiments are given. In no way should the following examples be read to limit or define the scope of the claims.

### Example

The following experiment was conducted to test the feasibility of combining an active component with a liquid gel concentrate to make a single-component fracturing fluid.

A liquid gel concentrate (LGC-36 UC) was prepared with a final gelling agent concentration of 4.5 lbm/gal. In particular, 83.3 g of WG-36™ Gelling Agent (available from Halliburton Energy Services) was dispersed in mineral oil in the presence of 2.3 g of clay (BENTONE® 155, available from Elementis Specialties), 0.78 mL of surfactant, and 1 g of boric acid (a crosslinker). This composition was then mixed under high speed to make the liquid gel concentrate. The liquid gel concentrate was dispersed in water at a concentration of 30 lbm/1000 gal gel, the pH was raised to about 9.0, and the mixture was heated to 140° F. to crosslink the fluid.

For hydration-rate comparisons, apparent viscosity measurements were taken at different time intervals for both (1) the crosslinked LGC-36 UC liquid gel concentrate as prepared above and (2) an equivalent concentration of WG-36™ Gelling Agent powder in water. As shown below in Table 1, only a marginal effect on gel hydration rate and final viscosity was observed when a crosslinker and liquid gel concentrate was pre-blended.

TABLE 1
Base Gel Hydration of LGC-WG-36
(Apparent Viscosity Values at 511 s⁻¹)

| Polymer (Concentration) | 3 min | 5 min | 10 min | 20 min | 30 min |
|---|---|---|---|---|---|
| LGC-36 UC (30 lbm/ | 15 | 20 | 25 | 25 | 26 |
| 1,000 gal) | | | | | |
| WG-36 ™ Powder (30 lbm/ | 15 | 25 | 25 | 25 | 27 |
| 1,000 gal) | | | | | |

An embodiment of the present disclosure is a method comprising: providing a liquid gel concentrate package comprising: a liquid gel concentrate; and at least two active ingredients, wherein the active ingredients comprise constituents of a well servicing fluid; and allowing the liquid gel concentrate package to blend with an aqueous fluid to form a well servicing fluid; and introducing the well servicing fluid into a wellbore penetrating at least a portion of a subterranean formation. Optionally, the well servicing fluid is a fracturing fluid. Optionally, at least one of the active ingredients comprises a constituent selected from the group consisting of: a viscosifier, a friction reducer, a pH control agent, a surfactant, a crosslinker, a clay stabilizer, a breaker, a pH adjusting agent, a scale inhibitor, a biocide, an inorganic ion crosslinker, and any combination thereof. Optionally, the liquid gel concentrate comprises a gelling agent and a liquid hydrocarbon. Optionally, the liquid gel concentrate package further comprises at least one inactive ingredient. Optionally, the inactive ingredient comprises a compound selected from the group consisting of: a carrier fluid, a suspending agent, and any combination thereof. Optionally, the method further comprises mixing the well servicing fluid using mixing equipment.

Another embodiment of the present disclosure is a method comprising: providing a liquid gel concentrate package comprising: a liquid gel concentrate; and at least two active ingredients, wherein the active ingredients comprise constituents of a well servicing fluid; and introducing the liquid gel concentrate package into a wellbore penetrating at least a portion of a subterranean formation; and allowing the liquid gel concentrate package to blend with an aqueous fluid in the portion of the subterranean formation. Optionally, the well servicing fluid is a fracturing fluid. Optionally, at least one of the active ingredients comprises a constituent selected from the group consisting of: a viscosifier, a friction reducer, a pH control agent, a surfactant, a crosslinker, a clay stabilizer, a breaker, a pH adjusting agent, an inorganic ion crosslinker, and any combination thereof. Optionally, the liquid gel concentrate comprises a gelling agent and a liquid hydrocarbon. Optionally, the liquid gel concentrate package further comprises at least one inactive ingredient. Optionally, the inactive ingredient comprises a compound selected from the group consisting of: a carrier fluid, a suspending agent, and any combination thereof. Optionally, the liquid gel concentrate package is introduced into the wellbore using one or more pumps.

Another embodiment of the present disclosure is a composition comprising a liquid gel concentrate; and at least two active ingredient, wherein the active ingredients comprise constituents of a well servicing fluid. Optionally, the well servicing fluid is a fracturing fluid. Optionally, at least one of the active ingredients comprises a constituent selected from the group consisting of: a viscosifier, a friction reducer, a pH control agent, a surfactant, a crosslinker, a clay stabilizer, a breaker, a pH adjusting agent, an inorganic ion crosslinker, and any combination thereof. Optionally, the liquid gel concentrate comprises a gelling agent and a liquid hydrocarbon. Optionally, the composition further comprises an inactive ingredient that comprises a compound selected from the group consisting of: a carrier fluid, a suspending agent, and any combination thereof. Optionally, the composition further comprises a water-soluble pouch that encloses the liquid gel concentrate and the active ingredients.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
providing a liquid gel concentrate package comprising:
a liquid gel concentrate; and
at least two active ingredients, wherein the active ingredients comprise constituents of a well servicing fluid; and
allowing the liquid gel concentrate package to blend with an aqueous fluid to form a well servicing fluid; and
introducing the well servicing fluid into a wellbore penetrating at least a portion of a subterranean formation.

2. The method of claim 1 wherein the well servicing fluid is a fracturing fluid.

3. The method of claim 1 wherein at least one of the active ingredients comprises a constituent selected from the group consisting of: a viscosifier, a friction reducer, a pH control agent, a surfactant, a crosslinker, a clay stabilizer, a breaker, a pH adjusting agent, a scale inhibitor, a biocide, an inorganic ion crosslinker, and any combination thereof.

4. The method of claim 1 wherein the liquid gel concentrate comprises a gelling agent and a liquid hydrocarbon.

5. The method of claim 1 wherein the liquid gel concentrate package further comprises at least one inactive ingredient.

6. The method of claim 5 wherein the inactive ingredient comprises a compound selected from the group consisting of: a carrier fluid, a suspending agent, and any combination thereof.

7. The method of claim 1 further comprising mixing the well servicing fluid using mixing equipment.

8. A method comprising:
providing a liquid gel concentrate package comprising:
a liquid gel concentrate; and
at least two active ingredients, wherein the active ingredients comprise constituents of a well servicing fluid; and
introducing the liquid gel concentrate package into a wellbore penetrating at least a portion of a subterranean formation; and
allowing the liquid gel concentrate package to blend with an aqueous fluid in the portion of the subterranean formation.

9. The method of claim 8 wherein the well servicing fluid is a fracturing fluid.

10. The method of claim 8 wherein at least one of the active ingredients comprises a constituent selected from the group consisting of: a viscosifier, a friction reducer, a pH control agent, a surfactant, a crosslinker, a clay stabilizer, a breaker, a pH adjusting agent, an inorganic ion crosslinker, and any combination thereof.

11. The method of claim 8 wherein the liquid gel concentrate comprises a gelling agent and a liquid hydrocarbon.

12. The method of claim 8 wherein the liquid gel concentrate package further comprises at least one inactive ingredient.

13. The method of claim 12 wherein the inactive ingredient comprises a compound selected from the group consisting of: a carrier fluid, a suspending agent, and any combination thereof.

14. The method of claim 8 wherein the liquid gel concentrate package is introduced into the wellbore using one or more pumps.

15. A liquid gel concentrate package comprising:
a liquid gel concentrate; and
at least two active ingredient, wherein the active ingredients comprise constituents of a well servicing fluid.

16. The liquid gel concentrate package of claim 15 wherein the well servicing fluid is a fracturing fluid.

17. The liquid gel concentrate package of claim 15 wherein at least one of the active ingredients comprises a constituent selected from the group consisting of: a viscosifier, a friction reducer, a pH control agent, a surfactant, a crosslinker, a clay stabilizer, a breaker, a pH adjusting agent, an inorganic ion crosslinker, and any combination thereof.

18. The liquid gel concentrate package of claim 15 wherein the liquid gel concentrate comprises a gelling agent and a liquid hydrocarbon.

19. The liquid gel concentrate package of claim 15 further comprising an inactive ingredient that comprises a compound selected from the group consisting of: a carrier fluid, a suspending agent, and any combination thereof.

20. The liquid gel concentrate package of claim 15 further comprising a water-soluble pouch that encloses the liquid gel concentrate and the active ingredients.
